(19) United States
(12) Patent Application Publication
(10) Pub. No.: US 2022/0343306 A1
(43) Pub. Date: Oct. 27, 2022

(54) PAYMENT SYSTEM COMPRISING MULTIPLE PAYMENT FUNCTION

(71) Applicant: COBOSYS. CO., LTD, Seoul (KR)

(72) Inventor: Jaehyoung Jeong, Seoul (KR)

(21) Appl. No.: 17/753,319

(22) PCT Filed: May 20, 2020
(86) PCT No.: PCT/KR2020/006599

§ 371 Date: Feb. 28, 2022

(30) Foreign Application Priority Data
Aug. 30, 2019 (KR) 10-2019-0107667

(51) Int. Cl. G06Q 20/18; G06Q 20/20; G06Q 20/14

(52) U.S. Cl. CPC G06Q 20/18; G06Q 20/207; G06Q 20/14; G06Q 20/202; G06Q 30/0237

(57) ABSTRACT

A billing system with multiple billing features, which is the technical idea of the present invention, is disclosed. According to an embodiment of the present disclosure, it includes: a kiosk including an environment setting unit for environmental setting of information on a plurality of servers being connected to a billing menu and a receipt format that is a billing result, and a billing menu unit providing a plurality of billing menus being connected to the plurality of servers; and a billing menu unit configured to provide a plurality of billing menus connected to the plurality of servers; and a plurality of servers in conjunction with the kiosk, wherein the plurality of servers may include any one or more among a first service provider server, a second service provider server, a representative service provider server, and a server of a card company

### STATEMENT RE: FEDERALLY SPONSORED RESEARCH/DEVELOPMENT

Not Applicable

### CROSS-REFERENCE TO RELATED APPLICATIONS

The present application is based on U.S. National Phase entry from International Application No. PCT/KR2020/006599, filed May 20, 2020, which claims priority to Korean Patent Application Number, 10-2019-0107667, filed on Aug. 30, 2019, the disclosure of which is incorporated by reference herein in its entirety.

### BACKGROUND

### Title of Invention

The present disclosure relates to a billing system with multiple billing features. Specifically, the present disclosure may provide a billing system with multiple billing features for processing billing two or more times.

### Background Art

A kiosk may be disposed in a store to connect a customer and the store when providing goods or services to the customer. The kiosk provides the customer with a billing menu for goods or services that can be provided in the store, so that the customer can select a billing menu corresponding to the desired goods or services and billing can be processed with a credit card. A kiosk of the prior art provides only a billing menu for goods or services provided by a store, and does not handle billing menus other than the billing menu for goods or service. For this reason, while commerce, which is a transaction of goods or services, is active, social donation culture such as donation fundraising is not spreading widely.

### BRIEF SUMMARY

### Technical Subject

The present disclosure may provide a billing system with multiple billing features that provide a donation billing menu in a kiosk. Specifically, the present disclosure may provide a billing system with multiple billing features that simultaneously process billing menu for goods or services and billing for donations.

Objects of the present disclosure are not limited to the objects mentioned above, and other objects not mentioned will be clearly understood from the description below.

### Technical Solution

A billing system with multiple billing features according to the first aspect includes a kiosk including an environment setting unit for environmental setting of information on a plurality of servers being connected to a billing menu and a receipt format that is a billing result, and a billing menu unit providing a plurality of billing menus being connected to the plurality of servers; and a billing menu unit configured to provide a plurality of billing menus being connected to the plurality of servers; and a plurality of servers interworking with the kiosk, wherein the plurality of servers may include any one or more among a first service provider server, a second service provider server, a representative service provider server, and a server of a card company.

In addition, the billing menu of any one among the plurality of billing menus may include a goods or service billing menu, and a donation billing menu may be included.

In addition, the goods or service billing menu is connected to the first service provider server, and the donation billing menu may be connected to the second service provider server.

In addition, a first receipt connected to the first service provider server is issued in response to the taxation service provider, and a second receipt connected to the second service provider server is issued in response to the tax-exempt service provider, so that income deduction may be processed differently.

In addition, the first or second receipt may include a link or QR code as server information.

In addition, the environment setting section may include: a server registration unit for registering information on the plurality of servers as server identification information including a server address, a port number, and a communication protocol; and a receipt format unit for registering a billing information format corresponding to the plurality of billing menus and a receipt format including information formats of the plurality of servers.

In addition, the kiosk may further include a discount donation unit configured to set a discount amount of the donation in relation to a preset amount unit of the goods or service amount connected to the goods or service billing menu.

In addition, the kiosk may cancel all related billings when an error occurs in a billing for any one billing menu including the goods or service billing menu, and the donation billing menu.

### Advantageous Effects

According to an embodiment of the present disclosure, a customer may select the donation billing menu while selecting the goods or service billing menu in the kiosk.

When customers use the donation billing menu together, the social donation culture can spread.

The effects of the present disclosure are not limited to the above effects, but it should be understood to include all effects that can be inferred from the configuration of the invention described in the detailed description or claims of the present disclosure.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a diagram schematically illustrating a billing system of a kiosk according to an embodiment.

FIG. 2 is a block diagram illustrating a configuration of a kiosk according to an embodiment.

FIG. 3 is an exemplary diagram illustrating a billing menu according to an embodiment.

FIG. 4 is an exemplary view showing a receipt according to an embodiment.

FIG. 5 is a diagram for explaining an operation of a discount donation unit according to an embodiment.

FIG. 6 is a flowchart illustrating a method of operating a kiosk according to an embodiment.

### DETAILED DESCRIPTION

### Best Mode

The terms used in the embodiments are selected as currently widely used general terms as possible while considering the functions in the present invention, but may vary depending on the intention or precedent of a person skilled in the art, the emergence of new technology, and the like. In addition, in a specific case, there are also terms arbitrarily selected by the applicant, and in this case, the meaning will be described in detail in the description of the corresponding invention. Therefore, the term used in the present invention should be defined based on the meaning of the term and the overall content of the present invention, rather than the name of a simple term.

In the entire specification, when a part “includes” a certain element, it means that other elements may be further included, rather than excluding other elements, unless otherwise stated. In addition, “˜ unit”, “˜ module”, and the like mean a unit that processes at least one function or operation, which may be implemented as hardware or software, or a combination of hardware and software.

### Best Mode for Carrying Out the Invention

Hereinafter, with reference to the accompanying drawings, embodiments of the present invention will be described in detail so that those of ordinary skill in the art can easily implement them. However, the present invention may be implemented in several different forms and is not limited to the embodiments described herein.

The billing system with multiple billing features includes a plurality of billing menus that are being connected to different service provider servers in a representative billing menu, so that multiple billing is made when the representative billing menu is selected. Multiple billing means that multiple billings occur instead of one time billing, and twice or more billing may occur when billing is processed one time with a credit card. In case of an IC billing, when billing occurs more than twice, customers may not recognize it, but in case of magnetic card billing, scratching the card more than twice is required. Credit card billing requires interworking between the card company server and the service provider server, and various billing methods such as IC billing, magnetic billing, and pay billing using a smartphone can be used. Here, the service provider may be an affiliated store of a card company. An example of a billing system of a kiosk that can be actually applied in a billing system including these multiple billing features is as follows.

Hereinafter, embodiments of the present disclosure will be described in detail with reference to the accompanying drawings.

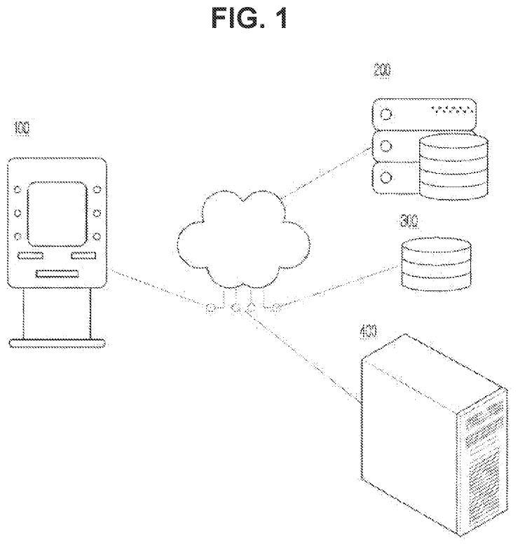

FIG. 1 is a diagram schematically illustrating a billing system of a kiosk according to an embodiment.

The billing system of a kiosk may include a first service provider server 200 interworking with the kiosk 100, a second service provider server 300, and a card company server 400. The kiosk 100 may provide a billing menu connected to the first service provider server 200 and the second service provider server 300. The kiosk 100 performs card billing through the card company server 400, and in FIG. 1, the first service provider server 200 and the second service provider server 300 may be interworking with the card company server 400.

The kiosk 100 may environmentally set information and a receipt format for the first service provider server 200, the second service provider server 300, and the card company server 400. The kiosk 100 may display a billing menu respectively connected to the first service provider server 200 and the second service provider server 300 together with server settings, and billing using the first service provider server 200 and the second service provider server 300 may be proceeded in the first service provider server 200 and the second service provider server 300 through the billing menu, respectively.

In another embodiment, the representative service provider servers representing the first service provider server 200 and the second service provider server 300 may interwork with the billing system of the kiosk 100. In this case, the representative service provider server may perform billing as a representative to the first service provider server 200 and the second service provider server 300, and divide the billing amount by the first service provider and the second service provider.

When the first service provider server 200 processes billings for goods or service and the second service provider server 300 processes billings for donation; the representative service provider server may simultaneously process billings for goods or service and billings for donation.

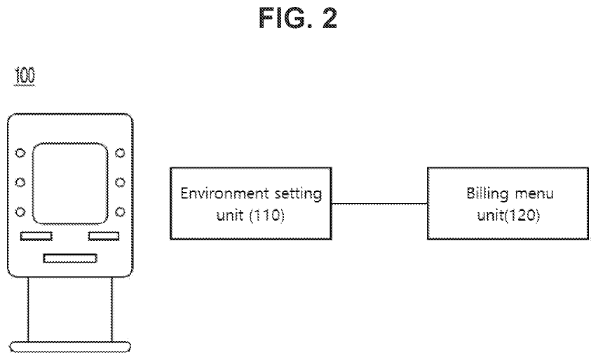

FIG. 2 is a block diagram illustrating a configuration of a kiosk according to an embodiment.

The kiosk 100 may be implemented as an embedded device, and the embedded device includes a computer, wherein the kiosk 100, including a processor, a memory, and a display as basic components, and provided with a commercial OS, may be implemented in the form of an application operating in the OS. For example, in the case of the computer, a processor of the computer may operate as an environment setting unit, and a display of the computer may operate as a billing menu unit. In the aspects of applications, the software structure may include an environment setting unit and a billing menu unit. These applications are created by an integrated development environment using a programming language according to various operating environments required by embedded devices.

The kiosk 100 is a device that assists in concluding a contract billing between a customer and a service provider when a store provides various goods or services. The kiosk 100 displays a billing menu consisting of a goods or service billing menu 31, a donation billing menu 32, and a representative billing menu 33 in which the goods or service billing menu and the donation billing menu are integrated. The kiosk 100 may register a plurality of server information connected to the billing menu for outputting the billing menu, and may register a receipt format including server information and billing information.

The kiosk 100 may have an environment setting unit 110 including a server registration unit for registering server information including a server address, port number, and communication protocol, and a receipt format unit for registering a receipt format including a billing information format and a server information format. In addition, the kiosk 100 may have a billing menu unit 120 that provides a billing menu that can be provided by a plurality of servers. The kiosk 100 may register server information connected to the billing menu through the environment setting unit 110 and register a receipt format being outputted during billing.

When the kiosk 100 completes the environmental setting through server registration, billing menu registration, and receipt format registration, it is ready to meet customers in the store. When a customer selects a desired billing menu from the billing menu displayed on the kiosk 100 and processes billing with a credit card, the customer can process billing of the goods or services and the donation at the same time. For example, when a customer selects the representative billing menu 33 and requests for credit card billing, goods or service billing and donation billing proceed individually in credit card billing; this is because the billing for goods or services is taxable while the billing for donation is tax-exempt, so the tax process is different and the service providers are different as well. In addition, the first service provider server 200 may be connected to goods or service billing, and the second service provider server 300 may be connected to donation billing.

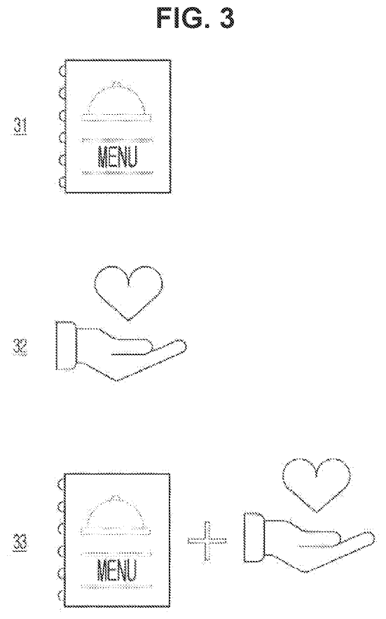

FIG. 3 is an exemplary diagram illustrating a billing menu according to an embodiment.

The kiosk 100 provides various types of billing menus to the customer so that the customer can select a desired billing menu; for example, the billing menu may include the goods or service billing menu 31, donation billing menu 32, representative billing menu 33.

The billing menu is composed of a goods or service billing menu 31, a donation billing menu 32, and a representative billing menu 33 in which the goods or service billing menu and the donation billing menu are integrated. The goods or service billing menu 31 is a billing menu for goods or services provided by the store, and the donation billing menu 32 is a billing menu connected to the donation collection conducted by the second service provider server 300, and the representative billing menu 33 is a billing menu in which the goods or service billing menu 31 being connected to the first service provider server 200 and the donation billing menu 32 being connected to the second service provider server 300 are integrated.

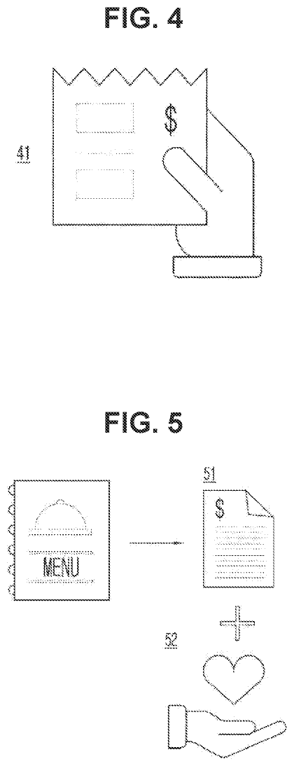

FIG. 4 is an exemplary view showing a receipt according to an embodiment.

The first receipt being outputted when billing the goods or services billing menu 31 is issued by the taxation service provider, and the second receipt being outputted when billing the donation billing menu 32 may be issued by the tax-exempt service provider. The first receipt issued by the taxation service provider and the second receipt issued by the tax-exempt service provider may be treated differently for income deduction. A receipt 41 may be outputted as a first receipt and a second receipt, and a link or QR code including server information may be printed on the first or second receipt. When the link or QR code is recognized, server information may be outputted from the application, and the server information may include service provider information and donation information.

FIG. 5 is a diagram for explaining an operation of a discount donation unit according to an embodiment.

The discount donation unit may donate by setting a discount amount of donation 52 in a money unit preset for the amount of goods or services 51 being billed when the item or service billing menu of the kiosk is selected. For example, when the amount of goods or services 51 is 6,780 won, 220 won may be donated as a discount amount of donation 52 in the case of a preset money unit of 1,000 won.

The discount donation unit donates the discount amount of donation 52 according to a preset money unit for the amount of goods or services 51, so that the customer can process billing of the amount of goods or services 51 and the discount amount of donation 52 by cutting in money unit of 1,000 won. The customer can donate without burdens by donating the discount amount of donation 52 cut in money unit of 1,000 won while using the goods or service being desired.

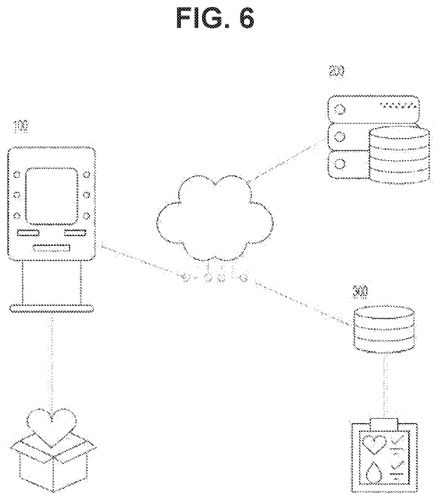

FIG. 6 is a flowchart illustrating a method of operating a kiosk according to an embodiment.

While processing a billing corresponding to the goods or service billing menu 31 and the donation billing menu 32 with the representative billing menu 33, the kiosk 100 may cancel all billings related to the representative billing menu when a billing error occurs in any one of the billing menus.

The second service provider server 300 adds up the donation amount, and when the target amount is reached, it notifies the kiosk 100 of achieving the target amount, so that the kiosk 100 can deregister the donation billing menu. If the donation billing menu is deregistered, it may disappear from the kiosk billing menu.

When the donation billing menu 32 in the kiosk 100 is deregistered, the second service provider server 300 requests another new type of donation collection to the kiosk, and the kiosk 100 may register a new donation billing menu. The second service provider server 300 may raise donation, achieve target amount, and raise a new donation. Multiple donations can be raised at the same time.

In addition, the second service provider server 300 may process in a way that by counting the number of selections of the donation billing menu selected by the same customer, so that the same customer selects the donation billing menu less than a certain number of times in the kiosk 100, and if the menu selection is more than a certain number of times, it can be processed not to proceed with donation billing. This can limit the total amount a customer can donate so that there is no burden from donation.

A representative service provider server representing the first service provider server 200 and the second service provider server 300 may be registered in the billing system of the kiosk 100 to simultaneously process billing for goods or services and billing for donations. The representative service provider server can divide the billing amount into goods or services and donations.

The server may be implemented as an embedded device, and the embedded device includes a computer, includes a processor, memory, and display as basic components, has a commercial OS, and the server may be implemented in the form of an application operating in the OS. These applications are created by an integrated development environment using a programming language according to various operating environments required by embedded devices. Programming used in the integrated development environment is divided into web, mobile app, and Windows app according to the computing environment interfaced with the user, and is divided into web programming, mobile programming, and window programming according to the type of application.

Web programming used in the server constitutes a web framework by combining html composed of tag definitions and document format definition css. In a web framework, the front end of the client end and the back end using a server side programming language exchange data with each other to create a huge web environment. The web environment is the main stage where the server operates, and the server communicates with mobile apps, console apps, and Windows apps in the web environment to provide computing services to users.

Meanwhile, the above described method can be written as a program that can be executed on a computer, and can be implemented in a general purpose digital computer that operates the program using a computer readable recording medium. In addition, the structure of the data used in the above method may be recorded in a computer readable recording medium through various means. The computer readable recording medium includes a storage medium such as a magnetic storage medium (e.g., ROM, RAM, USB, floppy disk, hard disk, and the like) and an optically readable medium (e.g., CD-ROM, DVD, and the like).

Those of ordinary skill in the art related to the present embodiment will understand that it can be implemented in a modified form within a range that does not depart from the essential characteristics of the above description. Therefore, the disclosed methods should be considered from an explanatory point of view, not from a restrictive point of view. The scope of the present invention is indicated in the claims rather than the foregoing description, and all differences within the scope equivalent thereto should be construed as being included in the present invention.

### Industrial Applicability

According to an embodiment of the present disclosure, the customer may select the donation billing menu while selecting the goods or service billing menu in the kiosk.

As customers use the donation billing menu together, the social donation culture can spread.

What is claimed is:

1. A billing system with multiple billing features comprising:
a kiosk including an environment setting unit for environmental setting of information on a plurality of servers being connected to a billing menu and a receipt format that is a billing result, and a billing menu unit providing a plurality of billing menus being connected to the plurality of servers; and a billing menu unit configured to provide a plurality of billing menus being connected to the plurality of servers; and
a plurality of servers interworking with the kiosk,
wherein the plurality of servers includes any one or more among a first service provider server, a second service provider server, a representative service provider server, and a server of a card company,
wherein a first receipt provided by the first service provider server is a taxable receipt for a taxation service provider, and a second receipt provided by the second service provider server is a tax-exempt receipt for a tax-exempt service provider,
wherein income deduction of each of the first receipt and the second receipt is processed differently,
wherein one billing menu among the plurality of billing menus includes a goods or service billing menu and a donation billing menu, the goods or service billing menu is connected to the first service provider server, the donation billing menu is connected to the second service provider server, and the first receipt or the second receipt includes a link or QR code as server information,
wherein the kiosk further includes a discount donation unit for determining the discount amount of the donation according to a preset money unit of the goods or service amount connected to the goods or service billing menu, and the kiosk processes the discount amount determined by cutting in the preset money unit as a donation,
wherein the kiosk cancels all related billings when an error occurs in a billing for any one billing menu including the goods or service billing menu, and the donation billing menu,
wherein the kiosk registers a plurality of donation billing menus based on a plurality of different types of donation collection information being requested from the second service provider server; when the target amount achievement information of the donation billing menu in which the sum of the donation amounts has reached the preset target amount is received from the second service provider server, the kiosk deregisters the donation billing menu that has reached the target amount from the billing menu, and
wherein the kiosk limits the total amount of donations and the number of donations through the donation billing menu for each user to less than or equal to a preset value.

2. The billing system with multiple billing features according to claim 1, wherein the environment setting unit including:
a server registration unit for registering the plurality of server information with server identification information including a server address, a port number, and a communication protocol; and
a receipt format unit for registering a billing information format corresponding to the plurality of billing menus and a receipt format including the plurality of server information formats.
